(19) United States
(12) Patent Application Publication
(10) Pub. No.: US 2009/0025319 A1
(43) Pub. Date: Jan. 29, 2009

(54) INSTALLATION SYSTEM FOR WINDOW AND DOOR ASSEMBLIES

(76) Inventors: Michael E. Westfall, Bend, OR (US); Budd W. Beatty, Bend, OR (US); Wallace D. Corwin, Bend, OR (US); Michael E. Stout, Bend, OR (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/828,875

(22) Filed: Jul. 26, 2007

(51) Int. Cl. E06B 3/00; E06B 7/14; E06B 7/16

(52) U.S. Cl. 52/204.5; 49/484.1; 52/741.4; 52/745.19; 52/747.1

(57) ABSTRACT

An installation system for use with a window assembly with a nailing fin in a rough opening of a wall, the rough opening including a sill. The system includes a sill drain mat including a barrier wedge with a front edge, a rear edge, a bottom surface and a top surface. A fiber layer includes a top surface and a bottom surface and an adhesive layer disposed on the bottom surface of the fiber layer. A first portion of the fiber layer is adhered to the top surface of the barrier wedge and extends inwardly, the first portion of the fiber layer including a sealing strip. A second portion of the fiber layer extends outwardly from the front edge and the bottom surface of the barrier wedge forms a mating surface with a sill of the rough opening. A gasket includes a first surface attached to an inner surface of the nailing fin, a second surface received adjacent an outer surface of the wall, and an outer edge comprising a protruding end extending along a length of the gasket. The protruding end is configured to receive an outer edge of the nailing fin along the length of the nailing fin.

### FIELD OF THE INVENTION

The present invention relates generally to window assemblies and door assemblies. More particularly, the present invention relates to systems and methods that may be used in window and door assemblies, including during installation of window or door assemblies in building structures.

### BACKGROUND OF THE INVENTION

Typical building structures frequently include window assemblies and door assemblies that are mounted in rough openings of their exterior walls. Typically, the rough openings are formed by framing members of the exterior walls. Because exterior walls are exposed or subjected to adverse environmental conditions, such as rain, wind, snow and ice, the juncture between the frame of the installed assembly and the rough opening formed in the exterior wall often serves as an entry point for air and water intrusion into the building structure. The introduction of moisture into the building structure can lead to warping, cracking, rotting, etc., of materials used in the construction of the structure (e.g. building envelope). Consequently, the damaged materials must be replaced or repaired, which is often costly. Moreover, damaged materials, such as dry-rotted wood, that are not replaced or repaired can compromise the integrity of the building structure and can also provide access to termites and like pests that can cause further structural damage.

In addition to the potential for allowing the introduction of moisture into the building structure, improper sealing of the juncture between the rough opening and the installed assembly can allow the passage of air both into and out of the building structure. As would be expected, the flow of air into and out of the building structure can adversely affect the insulation and, consequently, the energy efficiency of the structure. In some cases, construction techniques and materials have led to capturing water or moisture. This can lead to rotting of materials and mold growth within the building envelope. Recently, the growth of mold in building structures has been recognized to potentially cause health risks to building occupants.

Typical methods of installing window and door assemblies often include the use of multi-piece sill pans to help direct water from the rough opening and toward the outer surface of the structure. However, typical sill pans, because they are formed of multiple components, often require a high level of skill to properly install. As well, these systems frequently involve the use of caulking and/or putty to seal gaps between the various components of the sill pan, as well as gaps between the sill pan and the rough opening. The use of caulking and/or putty to seal gaps is problematic in that not only is a high level of skill often required, but the materials must be applied within the proper range of temperatures to ensure the materials set properly and adhere to the desired surfaces. Such building sealants crack or lose their adhesive properties over time, and must be reapplied periodically. Caulking and/or putty are also frequently used around the remainder of the installed assembly's frame to seal gaps between the frame and the outer surface of the wall. The above noted problems similarly exist when using these materials in this application.

Rather than using sill pans, other known methods of installation require the use of sill mats. Often, known sill mats include an adhesive layer disposed on the bottom of a barrier for adhering that barrier to the sill of the rough opening. As such, to ensure proper adhesion of the barrier to the sill, the sill mat must be installed during specific temperature ranges and/or moisture conditions.

Another existing method of installing window and door assemblies incorporates the use of flashing tape to seal the nailing fin of the assembly's frame to the surrounding portion of the outer surface of the wall to which the assembly has been secured. As with caulking and/or putty, the proper installation of flashing typically requires a high level of skill and the flashing tape must be applied during proper temperatures to ensure that the flashing tape adheres to both the nailing fin and the surrounding surface of the wall. Moreover, when the nailing fin and surrounding wall surface are not properly cleaned, flashing tape is prone to not adhere adequately to serve its intended purpose.

### SUMMARY OF THE INVENTION

The present invention recognizes and addresses considerations of prior art constructions and methods. One embodiment of the present invention provides an installation system for use in one of a window assembly or a door assembly including a nailing fin, the window or door assembly disposed in a rough opening of a wall, the rough opening including a sill. The system includes a sill drain mat including a barrier wedge including a front edge, a rear edge, a bottom surface and a top surface. A fiber layer includes a top surface and a bottom surface and an adhesive layer disposed on the bottom surface of the fiber. A first portion of the fiber layer is adhered to the top surface of the barrier wedge by the adhesive layer and extends inwardly from a front edge of the barrier wedge. The first portion of the fiber layer includes a sealing strip disposed along a back edge of the fiber layer and a second portion of the fiber layer extends outwardly from the front edge of the barrier wedge. The bottom surface of the barrier wedge forms a mating surface with a sill of the rough opening. A gasket including a first surface is fixedly attached to an inner surface of the nailing fin of the window or door assembly. The gasket includes a second surface configured to be received adjacent an outer surface of the wall about an outer periphery of the rough opening and an outer edge comprising a protruding end extending substantially along a length of the gasket. The protruding end configured to receive an outer edge of the nailing fin substantially along the length of the nailing fin.

Another embodiment of the invention includes a gasket for use in one of a window assembly or a door assembly including a nailing fin in a rough opening of a wall. The gasket includes a first surface configured to be received adjacent an inner surface of the nailing fin, a second surface configured to be received adjacent an outer surface of the wall about an outer periphery of the rough opening, and an outer edge that has a protruding end extending substantially along a length of the gasket. The protruding end is configured to receive an outer edge of the nailing fin substantially along a length of the nailing fin.

Yet another embodiment of the invention provides a sill drain mat for use in one of a window assembly or a door assembly in a rough opening of a wall. The sill drain mat includes a barrier wedge with a front edge, a rear edge, a bottom surface and a top surface. A fiber layer has a top surface and a bottom surface, and an adhesive layer is disposed on the bottom surface of the fiber layer. A first portion of the fiber layer is adhered to the top surface of the barrier wedge by the adhesive layer and extends inwardly from the front edge of the barrier wedge, a second portion of the fiber layer extends outwardly from the front edge of the barrier wedge and the bottom surface of the barrier wedge comprises a surface that is complementary to a sill of the rough opening.

Another embodiment of the invention provides a method of making a sill drain mat for use in one of a window assembly or a door assembly in a rough opening of a wall. The method includes providing a barrier wedge having a front edge, a rear edge, a bottom surface and a top surface, the top surface sloping downwardly from the rear edge to the front edge of the barrier wedge. The method also includes providing a fiber layer having a top surface and a bottom surface, and an adhesive layer disposed on the bottom surface of the fiber layer. The fiber layer includes a first portion and a second portion, the first portion of the fiber layer is adhered to the top surface of the barrier wedge by the adhesive layer and extends inwardly from the front edge of the barrier wedge. The first portion of the fiber layer includes a sealing strip disposed along a back edge of the fiber layer that is separated from the top surface of the barrier wedge by a removable release liner. The second portion of the fiber layer extends outwardly from the front edge of the barrier wedge, and the bottom surface of the barrier wedge forms a surface that is complementary to a horizontal surface of the rough opening.

Yet another embodiment of the invention provides a method of making a gasket for use in one of a window assembly or a door assembly including a nailing fin in a rough opening of a wall. The method includes providing a first surface that is configured to be received adjacent an inner surface of the nailing fin, providing a second surface that is configured to be received adjacent an outer surface of the wall about an outer periphery of the rough opening, and providing an outer edge including a protruding end extending substantially along a length of the gasket. The protruding end configured to receive an outer edge of the nailing fin along length of the nailing fin.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of an embodiment of a sill drain mat according to the present invention;

FIG. 2 is a perspective view of the sill drain mat as shown in FIG. 1 with the sealing strip bent outwardly away from the barrier wedge;

FIG. 3 is a perspective view of an embodiment of a gasket according to the present invention;

FIGS. 4A and 4B are cross-sectional views of the gasket as shown in FIG. 3, taken along line 4-4, attached to a nailing fin of a window assembly or door assembly;

FIG. 5A is a perspective view of a rough opening in a wall of a building structure;

FIGS. 5B through 5E are partial perspective views of the sill drain mat as shown in FIG. 1 being installed on a sill of the rough opening as shown in FIG. 5A;

FIGS. 5F and 5G are perspective views of a window assembly including the gasket as shown in FIG. 3 being mounted in the rough opening shown in FIGS. 5A through 5G;

FIG. 6 is a block diagram of a method according to the invention;

FIG. 7 is a partial cross-sectional view of the window assembly installed in the rough opening as shown in FIG. 5G, taken along line 7-7; and

FIG. 8 is a partial cross-sectional view of the window assembly installed in the rough opening as shown in FIG. 5G, taken along line 8-8.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. It will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

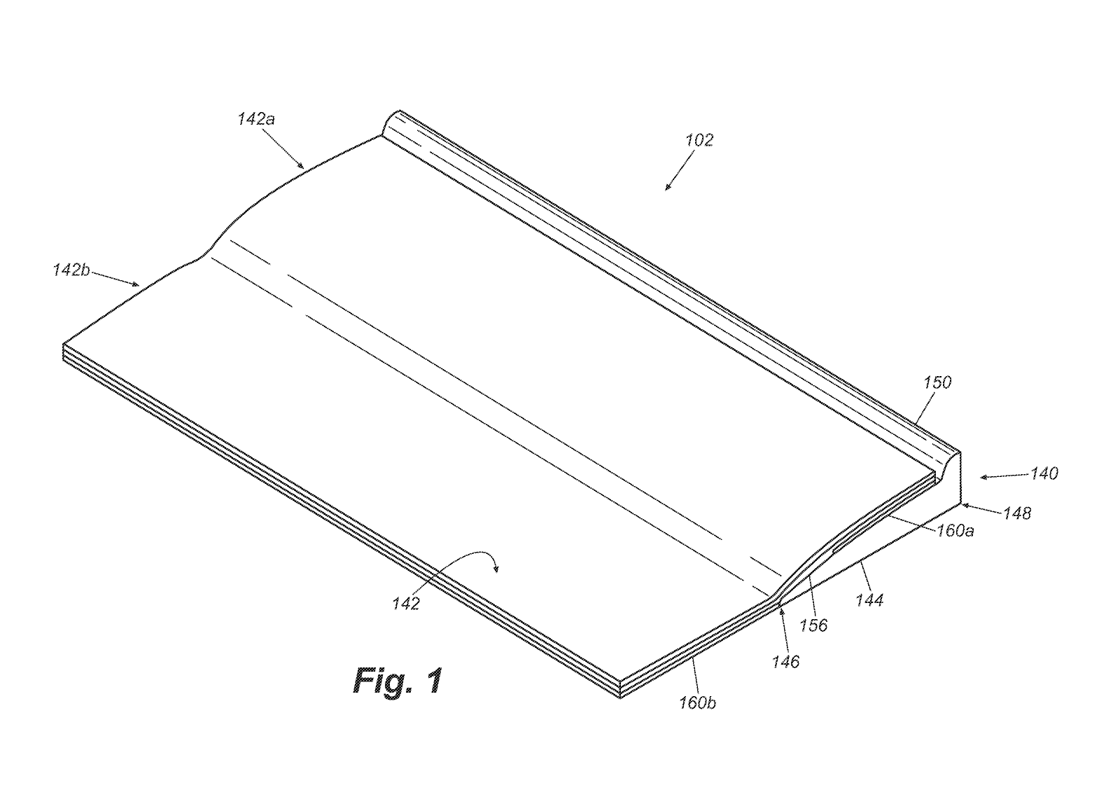

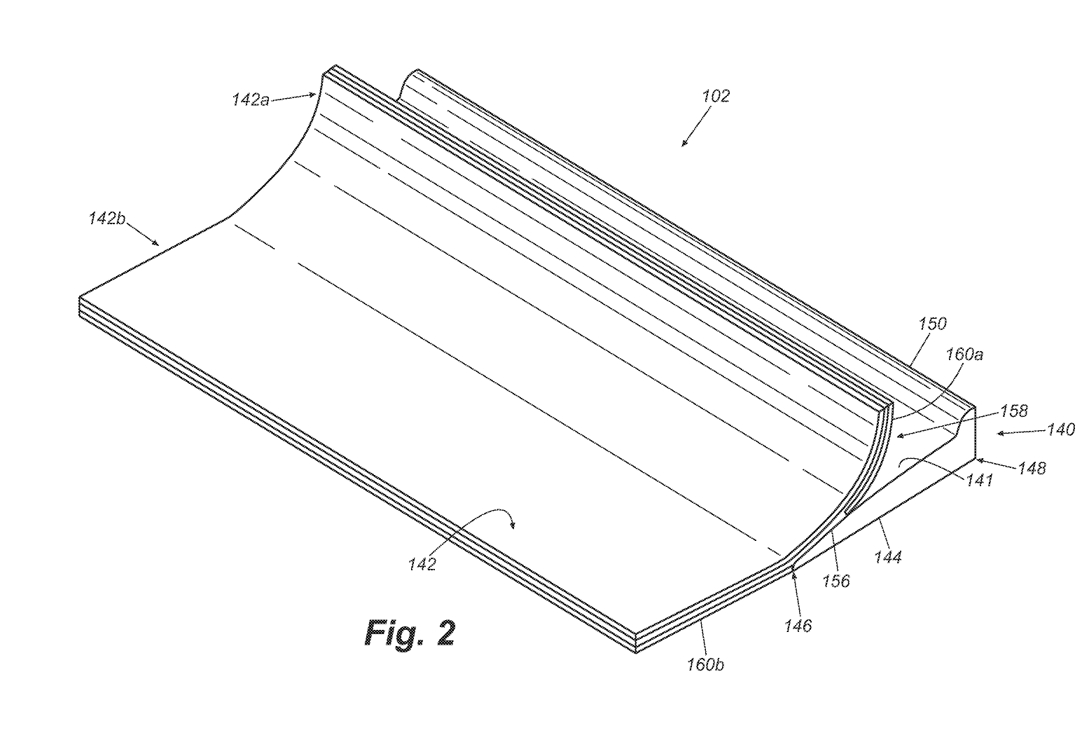

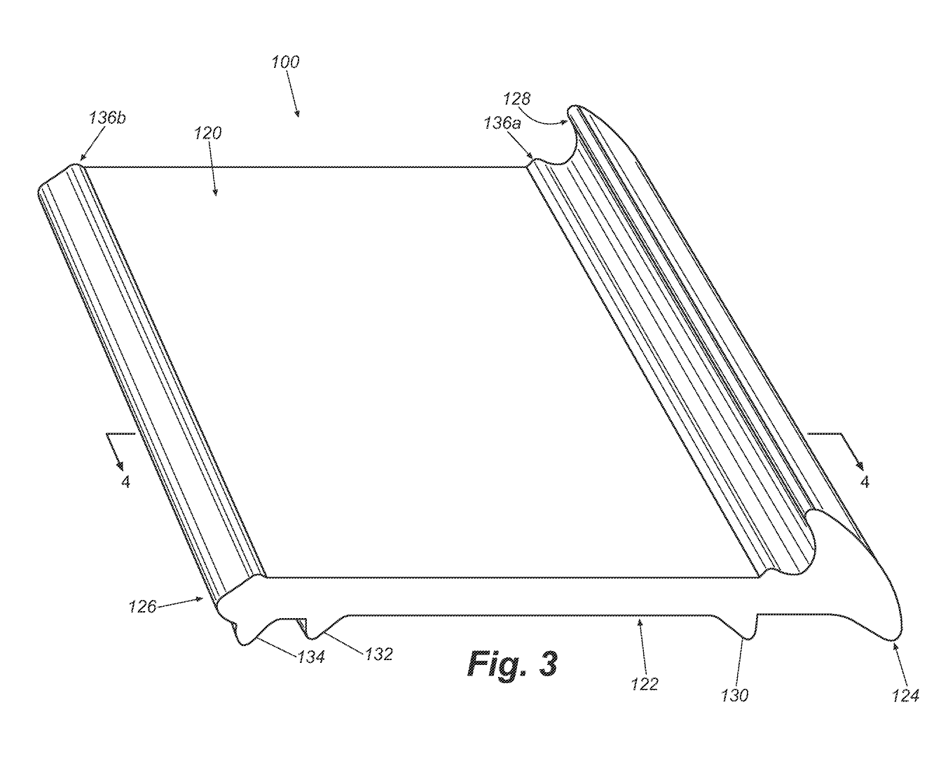

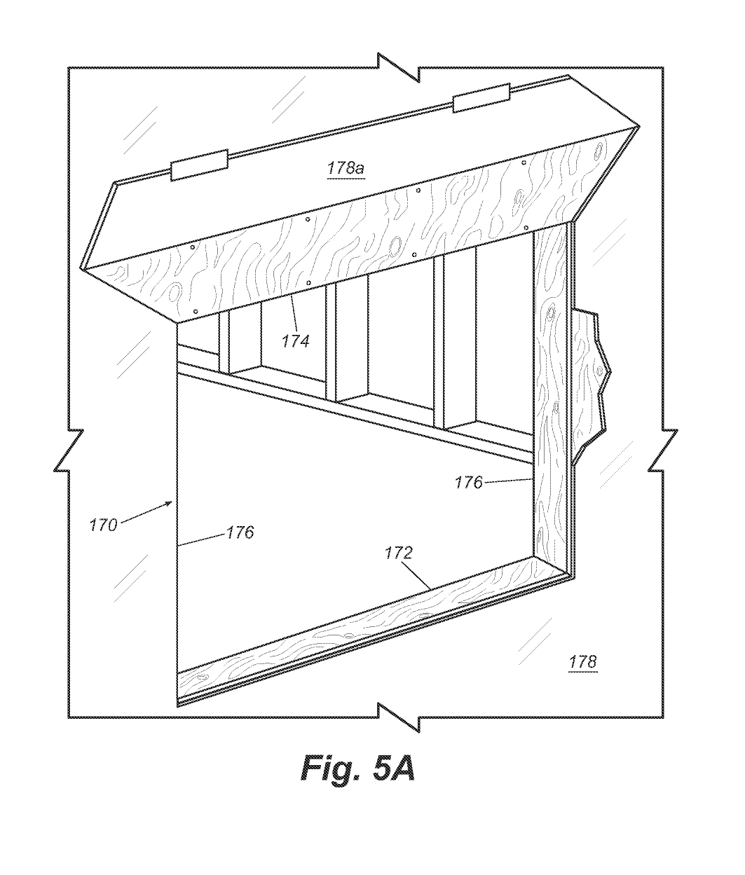

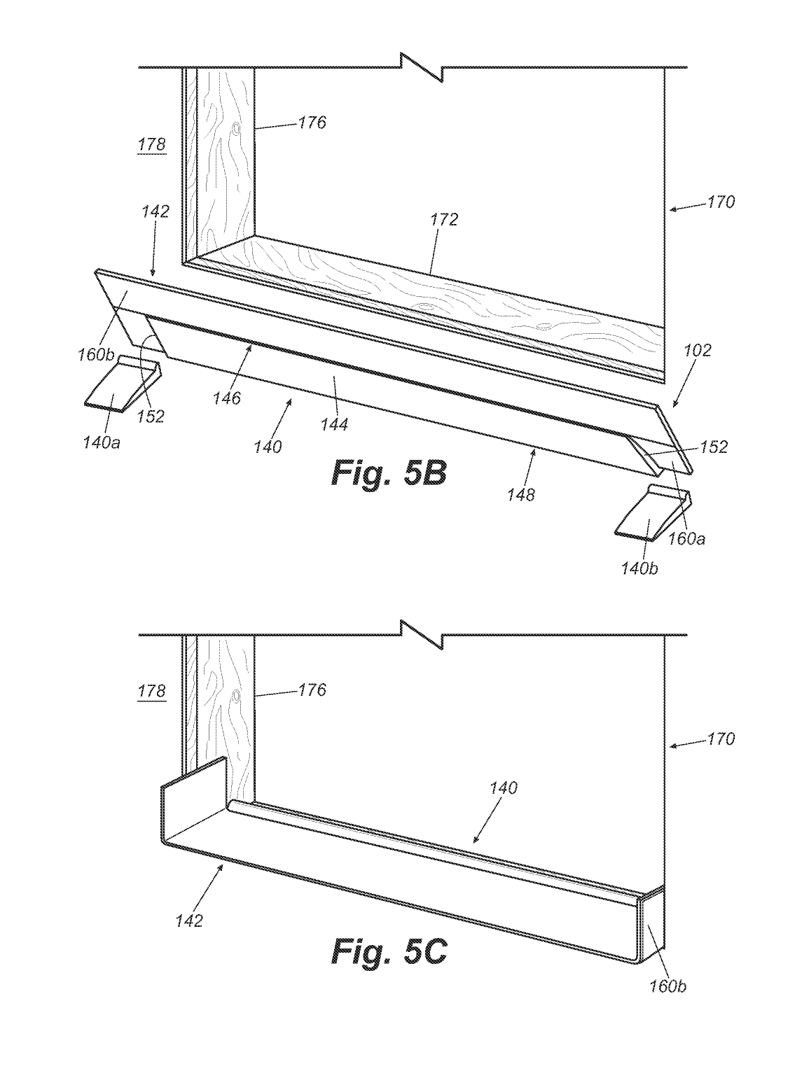

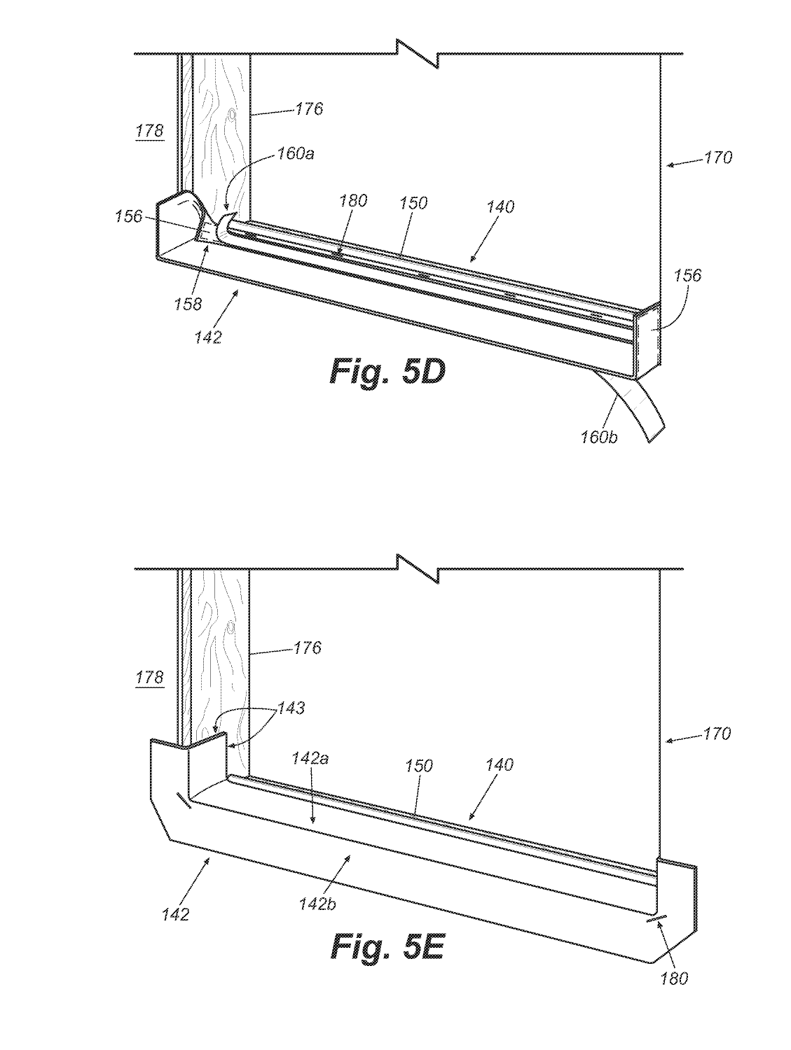

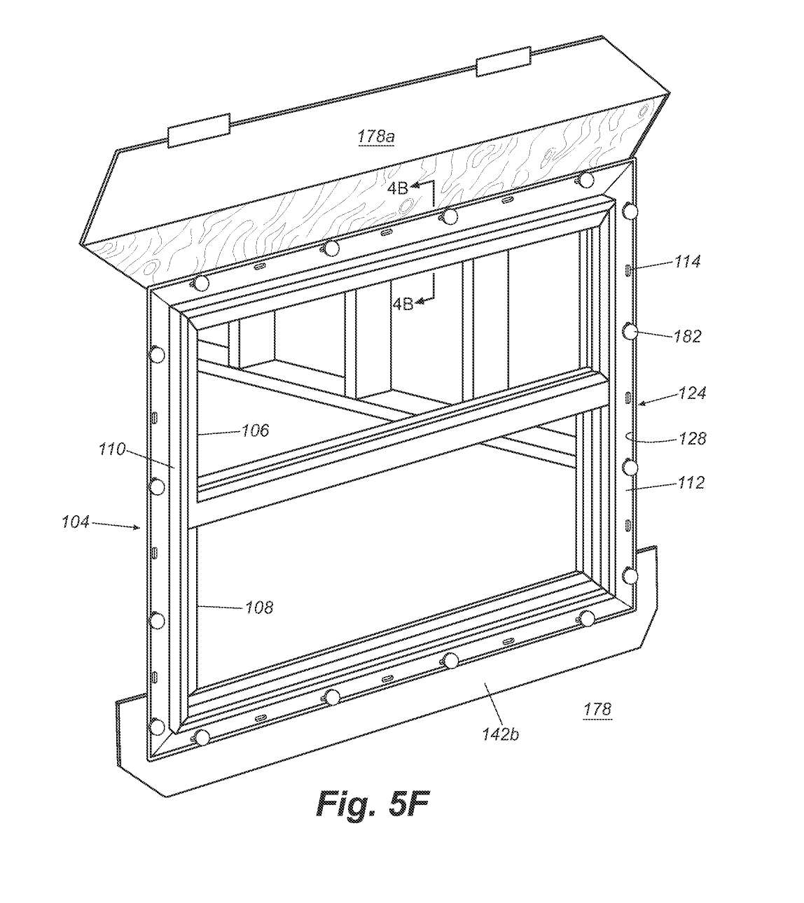

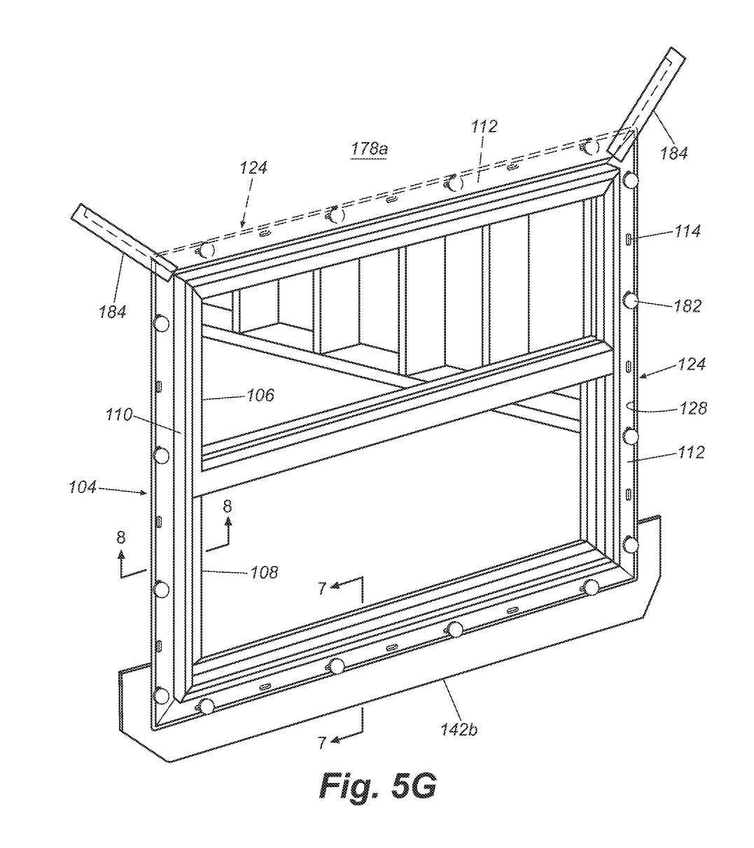

Referring now to the figures, a system for use in window assemblies and door assemblies in external wall openings of building structures, such as that shown in FIG. 5A, is disclosed. In an exemplary embodiment described below, the system includes a sill drain mat 102, as best seen in FIGS. 1 and 2, and a gasket 100, as best seen in FIG. 3, that are utilized in a window assembly 104 (FIGS. 5F and 5G) in a rough opening 170 (FIG. 5A) of a building structure (not shown), including during installation of the window assembly 104. Window assembly 104 includes a top sash 106 and bottom sash 108 that are slidably received within a frame 110 of the window assembly 104. Alternatively, the window assembly 104 may include other suitable window configurations, such as for example, a single hung window, a sliding window, or a casement window. A nailing fin 112 extends outwardly from the perimeter of frame 110 and includes a plurality of apertures 114 that are configured to receive fasteners, such as nails, so that window assembly 104 can be secured in rough opening 170 to the building structure. Rough opening 170 includes a sill 172, a head 174, and a pair of side jambs 176 extending therebetween. Rough opening 170 is sized such that nailing fin 112 of window assembly 104 extends outwardly beyond the perimeter of rough opening 170. The installation system described below is intended as an exemplary embodiment, and the system can be used on window assemblies of varying configurations, as well as door assemblies.

Referring to FIGS. 1 and 2, a preferred embodiment of sill drain mat 102 is shown. The sill drain mat 102 includes a barrier wedge 140 and a fiber layer 142 secured thereto. Barrier wedge 140 includes a top surface 141 and a substantially planar bottom surface 144 that extends from a front edge 146 to a back edge 148 of the barrier wedge 140. A back dam 150 extends upwardly from back edge 148 and beyond top surface 141 of barrier wedge 140. Preferably, top surface 141 slopes downwardly from back dam 150 to front edge 146 of barrier wedge 140. As such, and as described in greater detail below, the sloped top surface 141 of barrier wedge 140 helps to direct water that is received on sill drain mat 102 toward front edge 146 of barrier wedge 140 and subsequently toward the external surface of the building structure. Preferably, barrier wedge 140 is constructed from a closed cell thermoplastic polymer material, such as polyethylene foam, so that it is impermeable to water. However, various other materials exhibiting similar properties may be used in the construction of barrier wedge 140. Note also, although the exemplary embodiment of sill drain mat 102 includes a sloped top surface 141, various cross-sectional profiles of the barrier wedge can be utilized in alternate embodiments.

Fiber layer 142 may be laminated, or secured by other suitable means, to a top surface of an adhesive backing layer 156. Preferably, fiber layer 142 is a layer of non-woven polyester, or polyester blend, material. This combination provides a so-called wicking action (i.e., absorption of liquid into a material by capillary action) that moves water received on fiber layer 142 away from the rough opening and toward an outer surface of the wall. However, various other non-woven, as well as woven, materials can be used in alternate embodiments of fiber layer 142. Preferably, adhesive backing 156 is approximately a 0.025 inch thick layer of a butyl-based adhesive material.

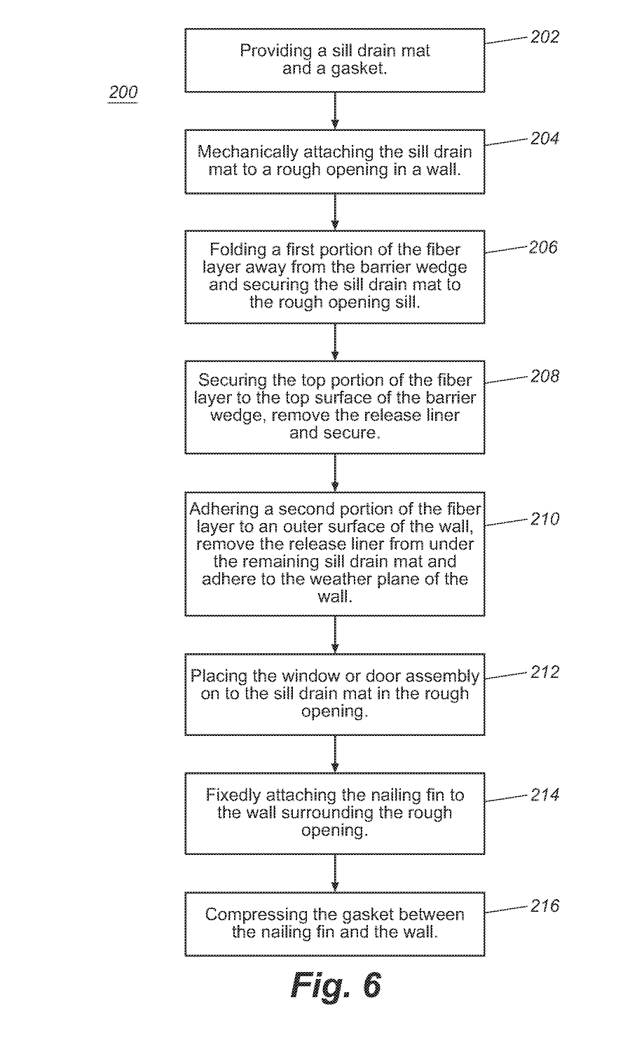

Fiber layer 142 includes an interior portion 142a and an exterior portion 142b. Interior portion 142a is disposed on top surface 141 of barrier wedge 140 and exterior portion 142b extends outwardly from front edge 146 of barrier wedge 140. As such, as discussed in greater detail below, after sill drain mat 102 has been installed in rough opening 170, interior portion 142a will be disposed within rough opening 170 while exterior portion 142b will be disposed on the outer surface, or weather plane, of the structure's wall, as best seen in FIG. 6. Interior portion 142a is secured to top surface 141 of barrier wedge 140 by a portion of adhesive backing layer 156 and includes a sealing strip 158 extending rearwardly toward back dam 150 of barrier wedge 140. Sealing strip 158 includes a removable release liner 160a disposed between adhesive backing layer 156 and top surface 141 of barrier wedge 140. As best seen in FIG. 2, sealing strip 158 is not adhesively secured to barrier wedge 140 until release liner 160a is removed and, therefore, sealing strip 158 can be folded outwardly from barrier wedge 140. Exterior portion 142b of fiber layer 142 also includes a removable release liner 160b that is left in place until sill drain mat 102 is installed in rough opening 170.

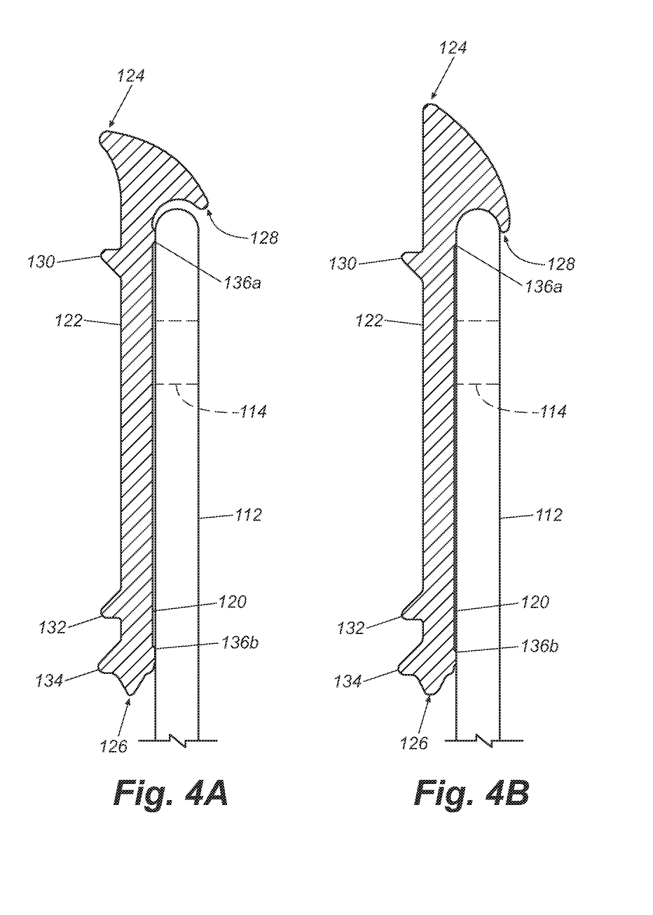

Referring now to FIGS. 3, 4A and 4B, an exemplary embodiment of gasket 100 is shown. Gasket 100 includes a first surface 120 that is configured to receive nailing fin 112, a second surface 122 that is configured to abut the outer surface of rough opening 170, an outer edge 124 and an inner edge 126. Second surface 122 is disposed in facing opposition to first surface 120 and includes a first ridge 130, a second ridge 132 and a third ridge 134 extending outwardly therefrom. As best seen in FIGS. 4A and 4B, first ridge 130 is disposed on second surface 122 adjacent outer edge 124 whereas second ridge 132 and third ridge 134 are disposed on second surface 122 adjacent inner edge 126. As such, when nailing fin 112 is received adjacent to first surface 120 of gasket 100, aperture 114 is disposed between first ridge 130 and second and third ridges 132 and 134, respectively. Therefore, water seepage through aperture 114 and gasket 100 due to, for example, a fastener passing therethrough is received between first ridge 130 and second and third ridges 132 and 134, respectively. Moreover, because gasket 100 is preferably constructed of a rubber-like material, the ridges are deformable such that they conform to imperfections in the outer surface of rough opening 170, thereby providing a substantially water-tight barrier thereabout.

First surface 120 of gasket 100 similarly includes a pair of inner ridges 136a and 136b extending outwardly therefrom, with inner ridge 136a being adjacent outer edge 124 and inner ridge 136b being adjacent inner edge 126. Inner ridges 136a and 136b are also disposed on opposing sides of aperture 114 when nailing fin 112 is received adjacent first surface 120 of gasket 100. Inner ridges 136a and 136b also define an area on first surface 120 of gasket 100 for receiving an adhesive layer (not shown) for adhering gasket 100 to nailing fin 112, as shown in FIGS. 4A and 4B. Preferably, gasket 100 is adhered to or co-extruded with nailing fin 112 during the manufacturing process of the window assembly. Alternatively, gasket 100 can be secured to nailing fin 112 after the manufacturing process, such as manually during installation of the window assembly in rough opening 170.

Outer edge 124 of gasket 100 includes a protruding end 128. As best seen in FIG. 4A, outer edge 124 of gasket 100 extends outwardly from second surface 122 of gasket 100 prior to installation of the window assembly in rough opening 170. Protruding end 128 includes a concave surface that is correspondingly shaped to the outer periphery of nailing fin 112. Prior to installation of the window assembly in the rough opening, a small gap exists between the concave surface of protruding end 128 and the outer periphery of nailing fin 112. As best seen in FIG. 4B, and as discussed in greater detail below, as nailing fin 112 of the window assembly is positioned adjacent to the outer surface of rough opening, outer edge 124 is cammed inwardly such that the concave surface of protruding end 128 abuts the outer periphery of nailing fin 112, thereby closing the gap that existed therebetween prior to installation of the window assembly. Note also, the outer surface of rough opening 170 will similarly cause first ridge 130, second ridge 132 and third ridge 134 to be similarly compressed and/or deflected depending upon how smooth the outer surface of the rough opening is that abuts second surface 122 of gasket 100.

Referring now to FIGS. 5A through 5G and 6, a method 200 according to an embodiment of the present invention is shown. FIG. 6 shows an exemplary embodiment of a method of installing a window or door assembly in a rough opening of a wall. More specifically, the method 200 may be employed to install the window assembly 104, as described above. However, the present invention may be employed to install a wide variety of other assemblies.

As indicated by block 202, a sill drain mat and a gasket are provided. The sill drain mat can be as that described above with reference to FIGS. 1 and 2. Alternatively, other suitable embodiments can be used for the sill drain mat. The gasket can be as that described above with reference to FIGS. 3, 4A and 4B. Alternatively, other suitable embodiments can be used for the gasket.

In one embodiment, the sill drain mat comprises a barrier wedge and a fiber layer. The barrier wedge includes a top surface and a bottom surface. The fiber layer is adhesively secured to the top surface of the barrier layer. The fiber layer includes a first portion disposed on the top surface of the barrier wedge and a second portion extending outwardly therefrom.

In one embodiment, the gasket is comprised of a compressible material and includes a protruding end extending along its length. The gasket is attached to an inner surface of a nailing fin of a window or door assembly. The protruding end of the gasket is adapted to engage an outer edge of the nailing fin when the gasket is compressed against the wall surface adjacent the nailing fin.

Installation of window assembly 104 in rough opening 170 of a building structure is discussed utilizing the exemplary embodiment of the installation system of the present invention. As best seen in FIG. 5A, a typical rough opening 170 includes a sill 172, a head 174, and a pair of side jambs 176 extending therebetween. As well, a building wrap 178 is typically used on the outer surface of a building structure's external walls. Prior to installation of window assembly 104, building wrap 178 is cut flush with the perimeter of rough opening 170 at sill 172, head 174 and side jambs 176. The outer surface of building wrap 178 is wiped down to remove as much dirt, debris, moisture, etc., as possible. Next, a flap 178a of building wrap 178 is created adjacent head 174 of rough opening 170 by cutting building wrap 178 from both corners where head 174 and side jambs 176 meet. Preferably, each cut in building wrap 178 is made at an approximate angle of 135 degrees with head 174. Flap 178a is folded upwardly and secured in position, such as by tape 184.

As indicated by block 204, the method 200 comprises mechanically attaching sill drain mat 102 to sill 172 of rough opening 170. As best seen in FIG. 5B, a length of sill drain mat 102 is created that is slightly longer than the length of sill 172. Preferably, sill drain mat 102 is produced in rolls, which are then cut to the desired length by the installer of the window assembly. For the preferred embodiment shown, sill drain mat 102 is cut to a length that exceeds the length of sill 172 by approximately six inches. Next, the installer makes equal length cuts at each end of barrier wedge 140 of the sill drain mat. Equal length portions 140a and 140b of barrier wedge 140 are then removed from adhesive backing layer 156 of fiber layer 142 and discarded. Each of equal length portions 140a and 140b is approximately three inches in length, meaning that the remaining portion of barrier wedge 140 is the same length as sill 172. Note, when cutting portions 140a and 140b off of barrier wedge 140, the installer uses care not to damage adhesive layer 156 such that the water-tight integrity of the sill drain mat is maintained.

Referring now to FIG. 5C, bottom surface 144 of barrier wedge 140 is positioned adjacent the horizontal surface of sill 172. As best seen in FIG. 6, barrier wedge 140 is positioned on sill 172 such that front edge 146 of barrier wedge 140 extends along the outermost edge of sill 172. As well, because barrier wedge 140 is the same length as sill 172, opposed ends 152 (FIG. 5B) of barrier wedge 140 abut respective side jambs 176 when barrier wedge 140 is positioned on sill 172. Fiber layer 142 is extended outwardly from rough opening 170 with the end portions positioned adjacent their respective side jambs 176.

As best seen in FIG. 5D, and as indicated by block 206, the method 200 comprises folding sealing strip 158 of fiber layer 142 away from the top surface of barrier wedge 140 and mechanically securing sill drain mat 102 to sill 172 of rough opening 170 with fasteners. In the preferred embodiment shown, staples 180 are passed through barrier wedge 140 and into sill 142 along the length of barrier wedge 140 between its front edge 146 and back edge 148. By so positioning the staples, deformation of barrier wedge 140, and therefore back dam 150, is minimized.

Next, as indicated by block 208, the method 200 comprises removing release liner 160a from sealing strip 158 and adhering sealing strip 158 to both the top surface of barrier wedge 140 and side jambs 176. As such, the staples securing barrier wedge are disposed beneath sealing strip 158 (FIG. 6), thereby preventing water seepage through barrier wedge 140 by way of the holes created by the staples. Similarly, as indicated by block 210, the method 200 also comprises removing release liner 160b from exterior portion of fiber layer 142 such that the exterior portion can be adhered to the outside surface of the wall, more specifically building wrap 178.

Referring now to FIG. 5E, after interior portion 142a and exterior portion 142b of fiber layer 142 have been adhesively secured to the interior portion of rough opening and the exterior surface of the wall, respectively, opposed corners 143 of interior portion 142a are caulked, or otherwise secured, and exterior portion 142b is further secured in place by staples 184. Rough opening 170 is now prepared to receive window assembly 104.

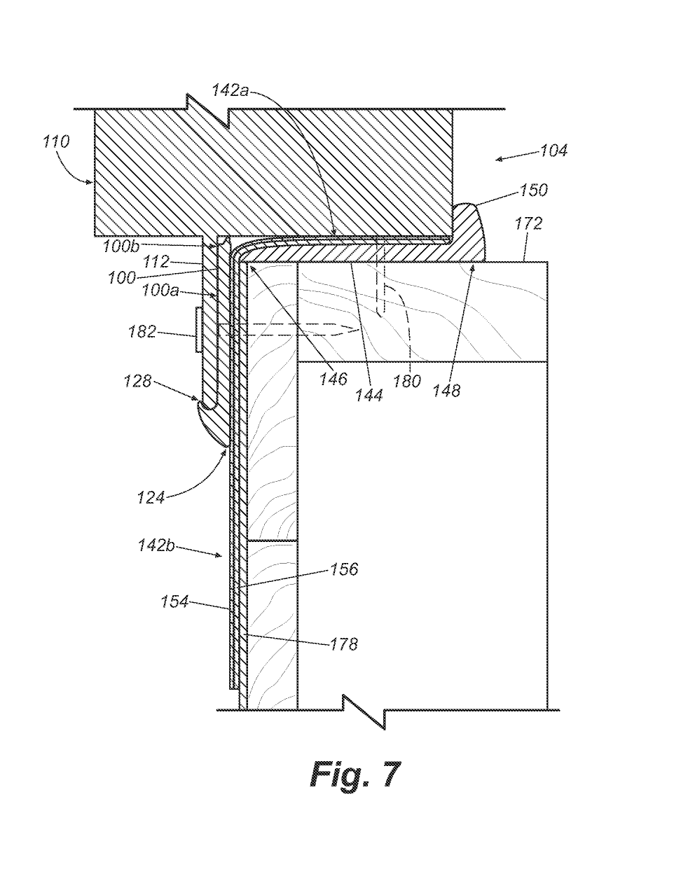

As best seen in FIG. 5F, and as indicated by block 212, the method 200 comprises placing window assembly 104 on top of sill drain mat 102 in rough opening 170 after sill drain mat 102 has been installed in rough opening 170, as described above. First, window assembly 104 is positioned in rough opening 170 such that nailing fin 112 and attached gasket 100 extend beyond the perimeter of rough opening 170 on all sides. As well, window assembly 104 is positioned on top of barrier wedge 140 such that the innermost portion of window frame 110 is positioned outwardly of back dam 150, as best seen in FIG. 7. Preferably, by so positioning window frame 140 on barrier wedge 140, back dam 150 will not be noticeably deformed and will prevent any incidental water from passing inwardly into rough opening 170. Next, window assembly 104 is secured in the desired position by placing shims (not shown) between the frame of the window assembly and side jambs 176 of rough opening 170 from inside the building structure. Next, the installer verifies that window assembly 104 is level, plumb and square.

As indicated by block 214, the method 200 comprises fixedly attaching nailing fin 112 to the wall. After verifying proper positioning of window assembly 104, fasteners (such as nails 182) are passed through apertures 114 formed in nailing fin 112 and into sill 172, head 174, and side jambs 176. As best seen in FIG. 4B, and as indicated by block 216, the method 200 comprises compressing gasket 100 between nailing fin 212 and the wall. Upon securing window assembly 104 to rough opening 170 with nails, outer edge 124 of gasket 100 is urged toward nailing fin 112 such that the concave surface of protruding end 128 engages the outer periphery of nailing fin 112. Suitable alternate embodiments include gaskets 100 wherein protruding end 128 engages the outer periphery of nailing fin 112 prior to securing window assembly 104 in rough opening 170.

Referring now to FIG. 5G, flap 178a of building wrap 178 as folded downwardly over the top section of nailing fin 112 and secured in place by pieces of tape 184 that are positioned over the cuts previously made in the building wrap. So positioned, flap 178a is disposed over the top portion of nailing fin 112 and the fasteners received therein. Precipitation flowing or traveling down the outside of the exterior wall is directed toward frame 110 of window assembly 104 rather than against the juncture of nailing fin 112 and the outer surface.

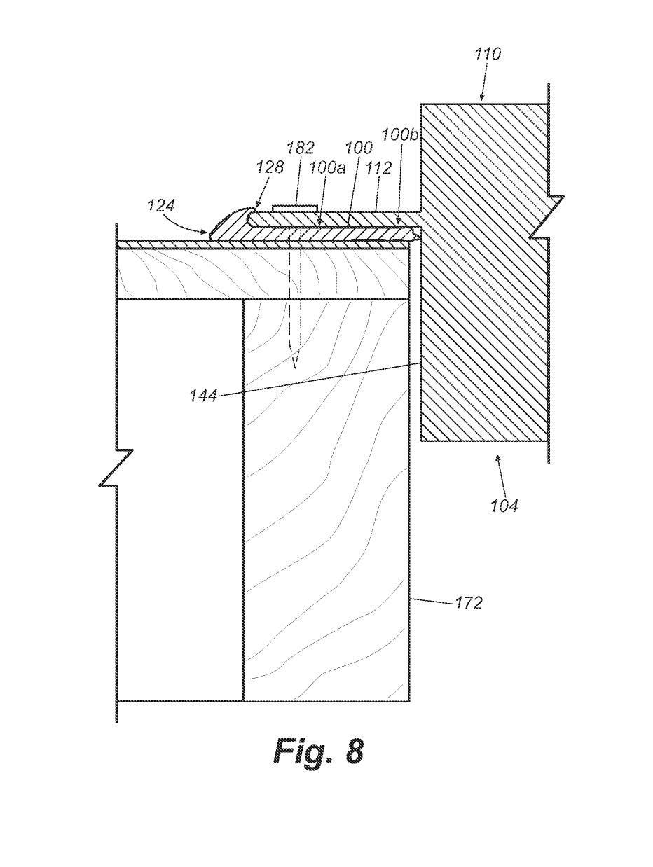

Referring now to FIG. 7, after the installation of the window assembly in rough opening 170 is complete, the gasketed frame installation system according to the present invention helps prevent the entry of water and air into the building structure by way of the rough opening. More specifically, those portions 100a of gasket 100 that are disposed between nailing fin 112 and the outer surface of the rough opening are compressed and help to seal any imperfections that exist in the outer surface of the wall about rough opening 170. Preferably, as best seen in FIGS. 7 and 8, gasket 100 is compressed across its full width about the full perimeter of nailing fin 112. In the exemplary embodiment shown, gasket 100 can be compressed to approximately one-third of its initial width. As well, fiber layer 142 of the mat is designed to prevent the passage of air into rough opening 170 while allowing incidental water that may reach inner portion 142a of fiber layer 142 to be wicked outwardly and away from rough opening 170 to exterior portion 142b where it evaporates or flows away from the building structure.

While one or more preferred embodiments of the invention are described above, it should be appreciated by those skilled in the art that various modifications and variations can be made in the present invention without departing from the scope and spirit thereof. For example, alternate embodiments can include barrier wedges having variously shaped cross-sectional profiles. As well, the cross-sectional profile of the concave surface of the gasket's protruding end can be square, polygonal, triangular, etc. It is intended that the present invention cover such modifications and variations as come within the scope and spirit of the appended claims and their equivalents.

What is claimed is:

1. A sill drain mat for use in one of a window assembly or a door assembly in a rough opening of a wall, the sill drain mat comprising:
a barrier wedge comprising a front edge, a rear edge, a bottom surface and a top surface; and
a fiber layer comprising a top surface and a bottom surface and an adhesive layer disposed on the bottom surface of the fiber layer,
wherein a first portion of the fiber layer is adhered to the top surface of the barrier wedge by the adhesive layer and extends inwardly from the front edge of the barrier wedge, a second portion of the fiber layer extends outwardly from the front edge of the barrier wedge, and the bottom surface of the barrier wedge comprises a surface that is complementary to a sill of the rough opening.

2. The sill drain mat of claim 1, wherein the top surface of the barrier wedge further comprises a sloped surface that slopes downwardly from the rear edge to the front edge of the barrier wedge.

3. The sill drain mat of claim 2, wherein the barrier wedge further comprises a back dam extending upwardly from the rear edge of the barrier wedge.

4. The sill drain mat of claim 1, wherein the barrier wedge is comprised of a closed cell thermoplastic polymer material.

5. The sill drain mat of claim 1, wherein the sill of the rough opening further comprises a horizontal surface.

6. The sill drain mat of claim 1, wherein the first portion of the fiber layer further comprises:
a sealing strip disposed along a back edge of the fiber layer; and
a removable release liner disposed between the bottom surface of the adhesive layer and the top surface of the barrier wedge.

7. The sill drain mat of claim 1, wherein the fiber layer further comprises a non-woven material.

8. The sill drain mat of claim 7, wherein the non-woven material further comprises polyester.

9. The sill drain mat of claim 1, wherein the adhesive layer further comprises a butyl adhesive material.

10. A gasket for use in one of a window assembly or a door assembly comprising a nailing fin in a rough opening of a wall, the gasket comprising:
a first surface configured to be received adjacent an inner surface of the nailing fin;
a second surface configured to be received adjacent an outer surface of the wall about an outer periphery of the rough opening; and
an outer edge comprising a protruding end extending substantially along a length of the gasket, the protruding end configured to receive an outer edge of the nailing fin substantially along a length of the nailing fin.

11. The gasket of claim 10, wherein the protruding end further comprises a concave surface extending substantially along the protruding end and shaped correspondingly to the outer edge of the nailing fin.

12. The gasket of claim 11, wherein the outer edge of the gasket extends outwardly from the second surface of the gasket and is urged toward the second surface of the gasket such that the concave surface of the protruding end engages the outer edge of the nailing fin.

13. The gasket of claim 11, wherein the gasket further comprises an adhesive layer disposed on the first surface of the gasket.

14. The gasket of claim 11, wherein the gasket further comprises a first pair of ridges extending outwardly from the second surface of the gasket, the first pair of ridges being substantially parallel to the outer edge of the gasket, wherein the first pair of ridges are deformed against the outer surface of the wall as the gasket is compressed between the outer surface of the wall and the nailing fin.

15. The gasket of claim 14, wherein the first pair of ridges are disposed on opposing ends of the second surface of the gasket, and wherein fastener-receiving apertures are disposed between the first pair of ridges.

16. The gasket of claim 11, wherein the gasket further comprises an ethylene propylene copolymer.

17. The gasket of claim 11, wherein the gasket further comprises a second pair of ridges extending outwardly from the first surface of the gasket, the second pair of ridges being substantially parallel to the outer edge of the gasket, wherein the second pair of ridges are deformed against the nailing fin as the gasket is compressed between the outer surface of the wall and the nailing fin.

18. A method of making a sill drain mat for use in one of a window assembly or a door assembly in a rough opening of a wall, the method comprising:
providing a barrier wedge comprising a front edge, a rear edge, a bottom surface and a top surface, the top surface sloping downwardly from the rear edge to the front edge of the barrier wedge; and
providing a fiber layer comprising a top surface and a bottom surface and an adhesive layer disposed on the bottom surface of the fiber layer,
wherein the fiber layer comprises a first portion and a second portion, the first portion of the fiber layer is adhered to the top surface of the barrier wedge by the adhesive layer and extends inwardly from the front edge of the barrier wedge, the first portion of the fiber layer comprises a sealing strip disposed along a back edge of the fiber layer that is separated from the top surface of the barrier wedge by a removable release liner, the second portion of the fiber layer extends outwardly from the front edge of the barrier wedge, and the bottom surface of the barrier wedge forms a surface that is complementary to a sill of the rough opening.

19. The method of making a sill drain mat of claim 18, further comprising providing a non-woven polyester material for the fiber layer.

20. A method of making a gasket for use in one of a window assembly or a door assembly comprising a nailing fin in a rough opening of a wall, the method comprising:
providing a first surface that is configured to be received adjacent an inner surface of the nailing fin;
providing a second surface that is configured to be received adjacent an outer surface of the wall about an outer periphery of the rough opening; and
providing an outer edge comprising a protruding end extending substantially along a length of the gasket, the protruding end configured to receive an outer edge of the nailing fin substantially along a length of the nailing fin.

21. The method of making a gasket of claim 20, further comprising providing a concave surface extending substantially along the protruding end of the gasket that is shaped correspondingly to the outer edge of the nailing fin.

22. The method of making a gasket of claim 21, further comprising providing an adhesive layer disposed on the first surface of the gasket.

23. The method of making a gasket of claim 21, further comprising providing a first pair of ridges extending outwardly from the second surface of the gasket that are disposed on opposing ends of the second surface of the gasket, wherein fastener receiving apertures on the nailing fin are disposed between the first pair of ridges, and the first pair of ridges is deformable.

24. An installation system for use in one of a window assembly or a door assembly comprising a nailing fin, the window or door assembly disposed in a rough opening of a wall, the rough opening comprising a sill, the system comprising:
a sill drain mat comprising:
a barrier wedge comprising a front edge, a rear edge, a bottom surface and a top surface; and
a fiber layer comprising a top surface and a bottom surface and an adhesive layer disposed on the bottom surface of the fiber layer, wherein a first portion of the fiber layer is adhered to the top surface of the barrier wedge by the adhesive layer and extends inwardly from a front edge of the barrier wedge, the first portion of the fiber layer comprising a sealing strip disposed along a back edge of the fiber layer, a second portion of the fiber layer extends outwardly from the front edge of the barrier wedge, and the bottom surface of the barrier wedge forms a mating surface with a sill of the rough opening; and
a gasket comprising:
a first surface fixedly attached to an inner surface of the nailing fin of the window or door assembly;
a second surface configured to be received adjacent an outer surface of the wall about an outer periphery of the rough opening; and
an outer edge comprising a protruding end extending substantially along a length of the gasket, the protruding end configured to receive an outer edge of the nailing fin substantially along a length of the nailing fin.

25. The installation system of claim 24, wherein the top surface of the barrier wedge further comprises a sloped surface that slopes downwardly from the rear edge to the front edge of the barrier wedge.

26. The installation system of claim 24, wherein the barrier wedge is comprised of a closed cell thermoplastic polymer material.

27. The installation system of claim 26, wherein the closed cell thermoplastic polymer is polyethylene.

28. The installation system of claim 24, wherein the fiber layer further comprises a non-woven polyester material adapted to wick water.

29. The installation system of claim 24, wherein the protruding end further comprises a concave surface extending along the protruding end and shaped correspondingly to the outer edge of the nailing fin.

30. The installation system of claim 29, wherein the outer edge of the gasket extends outwardly from the second surface of the gasket and is urged toward the second surface of the gasket such that the concave surface of the protruding end engages the outer edge of the nailing fin.

31. The installation system of claim 30, further comprising a first pair of ridges extending outwardly from the second surface of the gasket, wherein the first pair of ridges are disposed on opposing ends of the second surface of the gasket wherein fastener receiving apertures on the nailing fin are disposed between the first pair of ridges, and the first pair of ridges is compressable.

32. A method of installing a window or a door in a rough opening of a wall, the window or door comprising a nailing fin, the method comprising:
fixedly attaching a sill drain mat to a sill of the rough opening, the sill drain mat comprising a barrier wedge and a fiber layer;
placing the window or door adjacent the sill drain mat in the rough opening after fixedly attaching the sill drain mat to the sill, the window or door comprising a gasket attached to an inner surface of the nailing fin, the gasket comprising a protruding end extending substantially along a length of the gasket and receiving an outer edge of the nailing fin; and
fixedly attaching the nailing fin to the wall surrounding the rough opening.

33. The method of claim 32 further comprising compressing the gasket against the wall surrounding the rough opening, wherein the protruding end of the gasket engages the outer edge of the nailing fin.

34. The method of claim 32, wherein fixedly attaching the sill drain mat to the sill further comprises:
folding a first portion of the fiber layer away from a top surface of the barrier wedge;
securing the barrier wedge to the sill with a plurality of fasteners; and
securing the first portion of the fiber layer to the top surface of the barrier layer, wherein the plurality of fasteners are disposed underneath the first portion of the fiber layer.

35. The method of claim 34, further comprising removing a release liner from an adhesive layer of the first portion of the fiber layer and adhering the first portion of the fiber layer to the top surface of the barrier wedge with the adhesive layer.

36. The method of claim 32, further comprising adhering a second portion of the fiber layer to an outer surface of the wall adjacent the sill of the rough opening.

37. The method of claim 36, further comprising removing a release liner from the second portion of the fiber layer, thereby exposing an adhesive layer of the second portion, and adhering the second portion of the fiber layer to the outer surface of the wall with the release liner.

38. The method of claim 36, further comprising compressing the gasket against the wall surrounding the rough opening, wherein the second portion of the fiber mat is disposed between the gasket and the outer surface of the wall.
